(19) United States
(12) Patent Application Publication
(10) Pub. No.: US 2015/0022966 A1
(43) Pub. Date: Jan. 22, 2015

(54) PORT REPLICATOR

(71) Applicant: OZAKI INTERNATIONAL CO., LTD., NEW TAIPEI CITY (TW)

(72) Inventor: Hsin-Yen CHEN, New Taipei City (TW)

(73) Assignee: OZAKI INTERNATIONAL CO., LTD., NEW TAIPEI CITY (TW)

(21) Appl. No.: 14/163,167

(22) Filed: Jan. 24, 2014

(30) Foreign Application Priority Data
Jul. 19, 2013 (TW) 102213732

(51) Int. Cl. G06F 13/38; G06F 1/20

(52) U.S. Cl. CPC G06F 13/382; G06F 1/20
USPC 361/679.41

(57) ABSTRACT

A port replicator is applicable to an electronic device having one or more connecting port and includes a shell including an abutting portion and an extending portion connected with each other and a replicating circuit module. The insides of the abutting portion and the extending portion communicate with each other to form a receiving space. The abutting portion includes at least a downstream opening disposed at the front end of the abutting portion, one or more upstream openings disposed at the rear end of the extending portion, and a positioning slot disposed at the upper end of the abutting portion. The replicating module is assembled in the receiving space and includes at least one downstream port disposed corresponding to the downstream opening and one or more upstream port passing through the upstream opening and extended out of the shell.

### CROSS-REFERENCES TO RELATED APPLICATIONS

This non-provisional application claims priority under 35 U.S.C. §119(a) on Patent Application No. 102213732 filed in Taiwan, R.O.C. on Jul. 19, 2013, the entire contents of which are hereby incorporated by reference.

### BACKGROUND

1. Technical Field

The disclosure relates to a replicator, and particularly to a port replicator.

2. Related Art

As the developments of the technologies, various electronic devices, such as monitors, all-in-one desktops with different connecting interfaces are invented continuously. For beauty, the connecting ports are disposed at the rear sides of the electronic devices; however, the user can hardly connect other electronic devices with the electronic device via the connecting port disposed at the rear side of the electronic device due to the spatial limitations. Particularly, for a wall mounting type display hanged on the wall, there is almost no space for the user to insert a terminal of other device into the connecting port of the wall mounting type display. As a result, it is necessary to solve the difficulty of inserting a terminal of one electronic device into a connecting port of another electronic device in which the connecting port is disposed at the rear side of another electronic device.

### SUMMARY

In view of this, the disclosure provides a port replicator so as to solve the problems met in the prior arts.

The port replicator is applicable to an electronic device. A casing of the electronic device has a connecting port disposed at the rear face thereof. The port replicator includes a shell and a replicating circuit module.

The shell includes an abutting portion and an extending portion connected with each The inside of the abutting portion communicates with the inside of the extending portion to form a receiving space. The abutting portion includes at least a downstream opening, one or more than one upstream openings and a positioning slot. The downstream opening is at the front end of the abutting portion. The upstream opening is disposed at the rear end of extending portion. The positioning slot is disposed at the upper end of the abutting portion.

The replicating module is assembled in the receiving space and includes at least one downstream port and one or more than one upstream port. The downstream port is disposed corresponding to the downstream opening. The upstream port is passing through the upstream opening and extended out of the shell. Upon assembling, the upstream port is connected to the connecting port with parts of the bottom edge of the casing being positioned in the positioning slot.

Based on the above, via the port replicator, the plugging direction of the connecting port disposed behind the electronic device is switched to the front side of the electronic device to be plugged conveniently. Furthermore, the user can place the downstream device connected to the downstream port into the bending portion of the port replicator. Additionally, via the positioning slot, the heat dissipating holes of the electronic device are not shielded and the heat dissipation of the electronic device can be improved. Additionally, via the assembling of one or more than one upstream ports, downstream ports, and the replicating circuit module (including multiplexer/demultiplexer and protocol convertor), in the port replicator, the function of the connecting ports of the electronic device is multiplied, and the number of the downstream device connectable to the connecting port of the electronic device is also increased.

The detailed features and advantages of the disclosure are described below in great detail through the following embodiments, the content of the detailed description is sufficient for those skilled in the art to understand the technical content of the disclosure and to implement the disclosure there accordingly. Based upon the content of the specification, the claims, and the drawings, those skilled in the art can easily understand the relevant objectives and advantages of the disclosure.

### BRIEF DESCRIPTION OF THE DRAWINGS

The disclosure will become more fully understood from the detailed description given herein below for illustration only and thus not limitative of the disclosure, wherein:

FIG. 1 is an operating schematic view of a port replicator of a first embodiment of the disclosure;

FIG. 2 is a perspective view of the port replicator of the first embodiment of the disclosure;

FIG. 3 is a cross-sectional view along line A-A′ shown in FIG. 2;

FIG. 4 is an exploded view of the port replicator of the first embodiment of the disclosure;

FIG. 5A is a schematic assembled view of the port replicator of the first embodiment of the disclosure and an electronic device;

FIG. 5B is a partial enlarged view of the B region shown in FIG. 5A;

FIG. 6 is a perspective view of the port replicator of one implementation aspect of the first embodiment of the disclosure;

FIG. 7 is another perspective view of the port replicator of the first embodiment of the disclosure;

FIG. 8 is a schematic assembled view of the port replicator of one implementation aspect of the first embodiment of the disclosure and the electronic device;

FIG. 9A is a schematic assembled view of a port replicator of a second embodiment of the disclosure and an electronic device;

FIG. 9B is a partial enlarged view of the C region shown in FIG. 9A;

FIG. 10 is a perspective view of a port replicator of a third embodiment of the disclosure;

FIG. 11 is a perspective view of a port replicator of a fourth embodiment of the disclosure;

FIG. 12 is a perspective view of a port replicator of a fifth embodiment of the disclosure; and

FIG. 13 is a perspective view of a port replicator of a sixth embodiment of the disclosure.

### DETAILED DESCRIPTION

The spatial-relation terminological terms, for example, below, above, etc., are applied to describe the basic relationships between the members/features of the disclosure shown in the figures. It should be realized that, in addition to showing the orientational relationship of the members/features in the figures, the spatial-relation terminological terms also represents the orientational relationships of the members/features upon the disclosure is operating or corresponding to other devices. For example, when the disclosure shown in the figure is flapped, the member which is below another member will become above said another member. Therefore, the exemplary terminological term “below” can represent “disposed above . . . ” or “disposed below . . . ”. Similarly, the disclosure shown in the figures can be presented by other orientations (such as 90 degrees clockwise/counterclockwise rotation), corresponding to the operation state or receiving state of the disclosure.

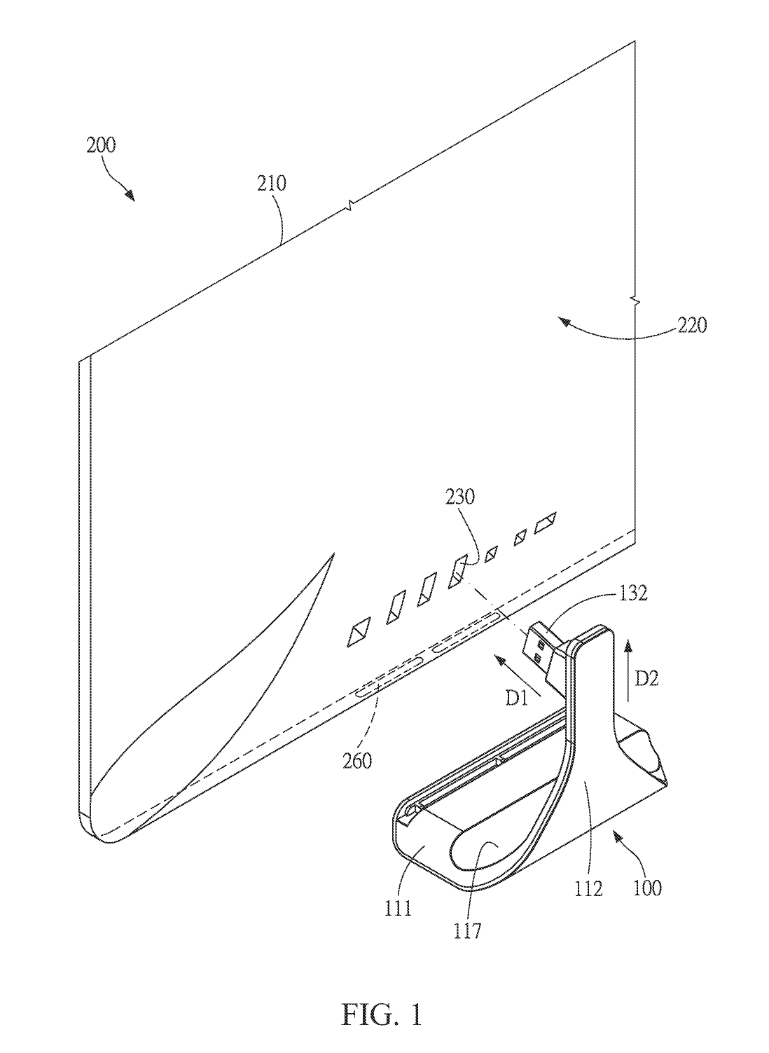

Please refer to FIG. 1, which is an operating schematic view of a port replicator 100 of a first embodiment of the disclosure.

The port replicator 100 is applicable to an electronic device 200, and a casing 210 of the electronic device 200 has a connecting port 230 disposed at the rear face 220 thereof. Here, the electronic device 200 can be a LCD display, an all-in-one desktop, etc. The connecting port 230 can be a port compatible with the USB interface, an audio plug, etc.

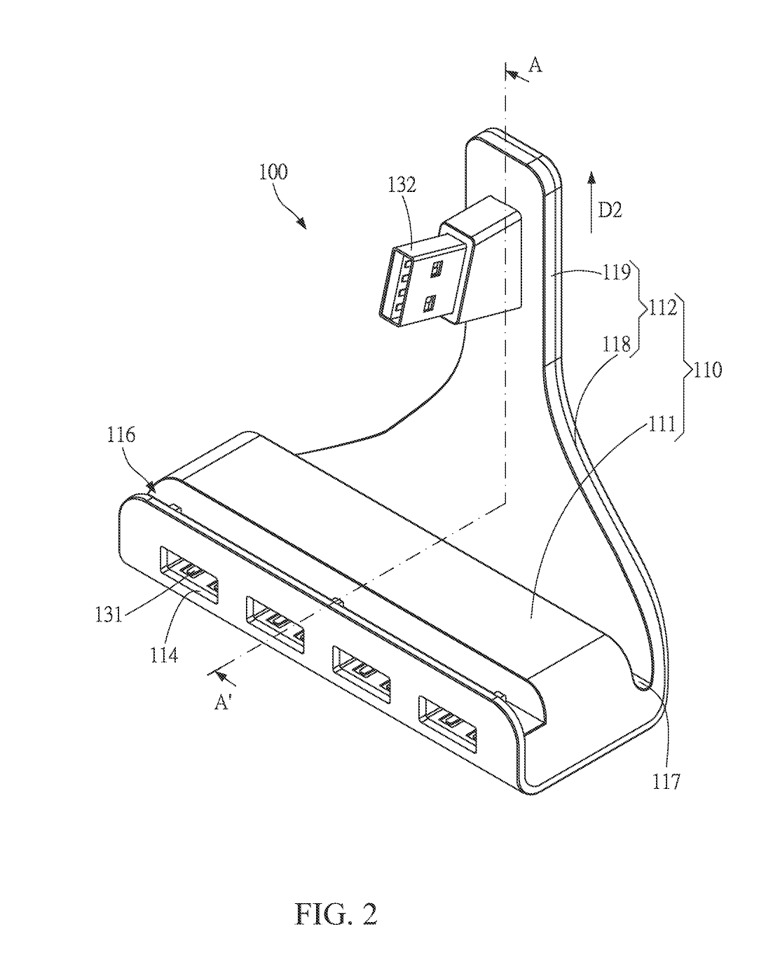

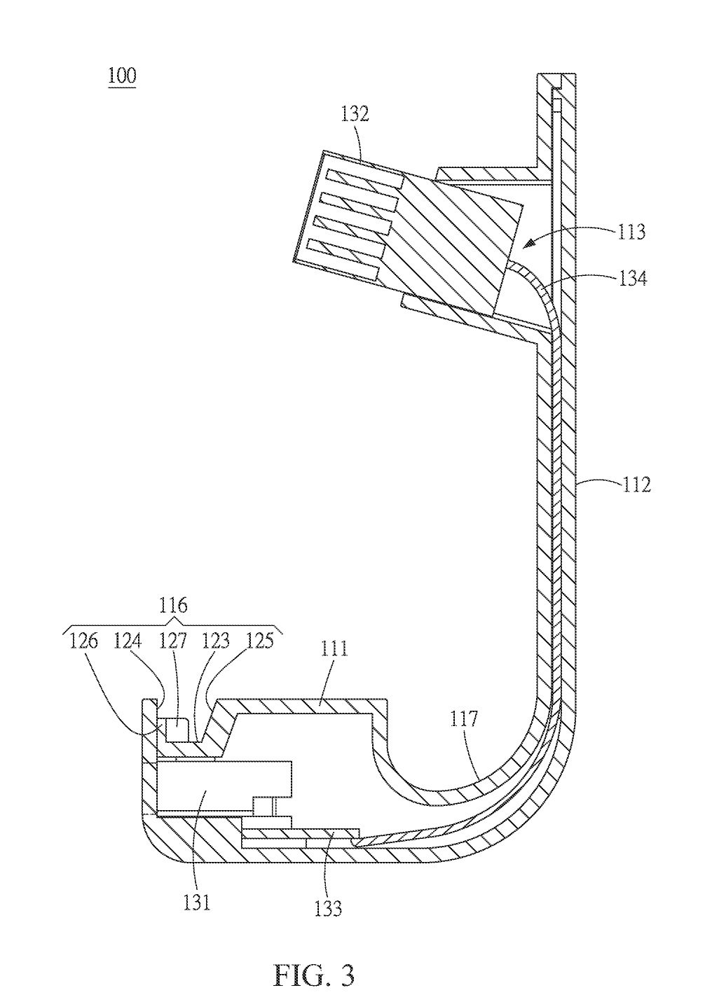

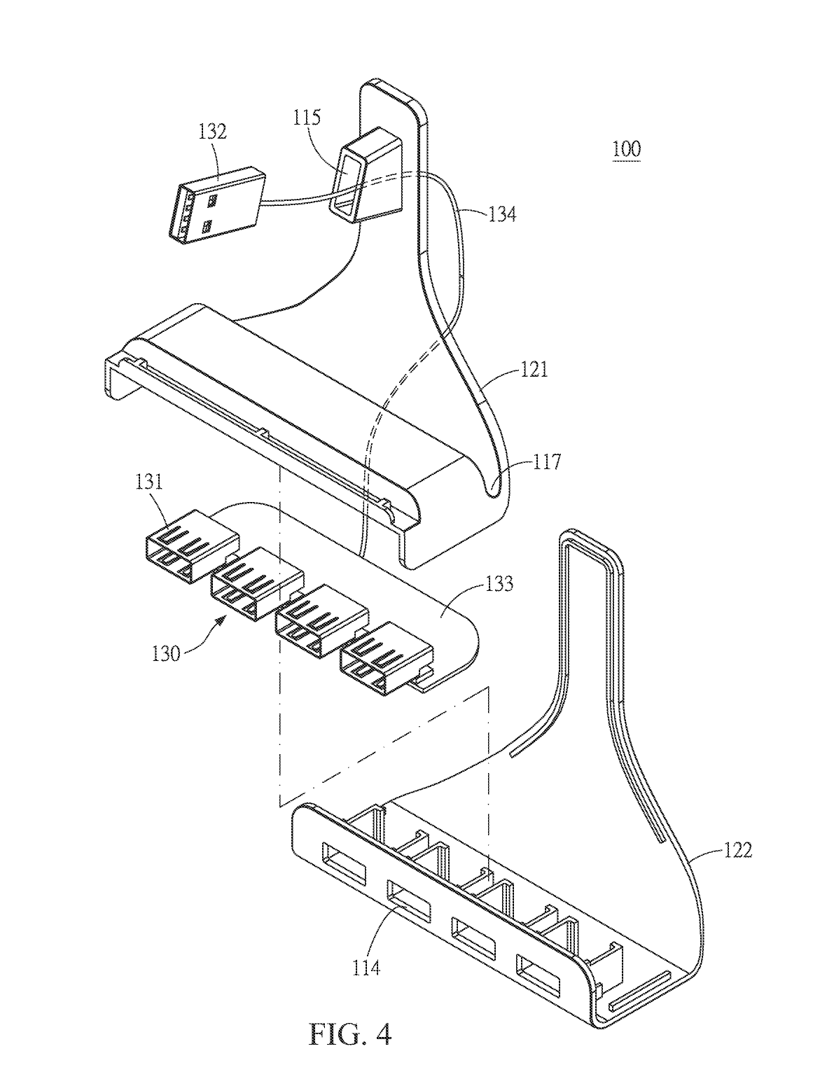

Please refer to FIGS. 2-4, of which FIG. 2 is a perspective view of the port replicator 100 of the first embodiment of the disclosure, FIG. 3 is a cross-sectional view along line A-A′ shown in FIG. 2, and FIG. 4 is an exploded view of the port replicator 100 of the first embodiment of the disclosure.

The port replicator 100 includes a shell 110 and a replicating circuit module 130. The shell 110 includes an abutting portion 111 and an extending portion 112 connected with each other. The inside of the abutting portion 111 communicates with the inside of the extending portion 112 to form a receiving space 113.

The abutting portion 111 includes at least one downstream opening 114 and an upstream opening 115 (in this embodiment, the abutting portion 111 includes a plurality of downstream openings 114.). The downstream opening 114 is disposed at the front end of the abutting portion 111. The upstream opening 115 is disposed at the rear end of the extending portion 112. The abutting portion 111 further includes a positioning slot 116 disposed at the upper end of the abutting portion 111. In this embodiment, the abutting portion 111 is approximately formed as a cuboid.

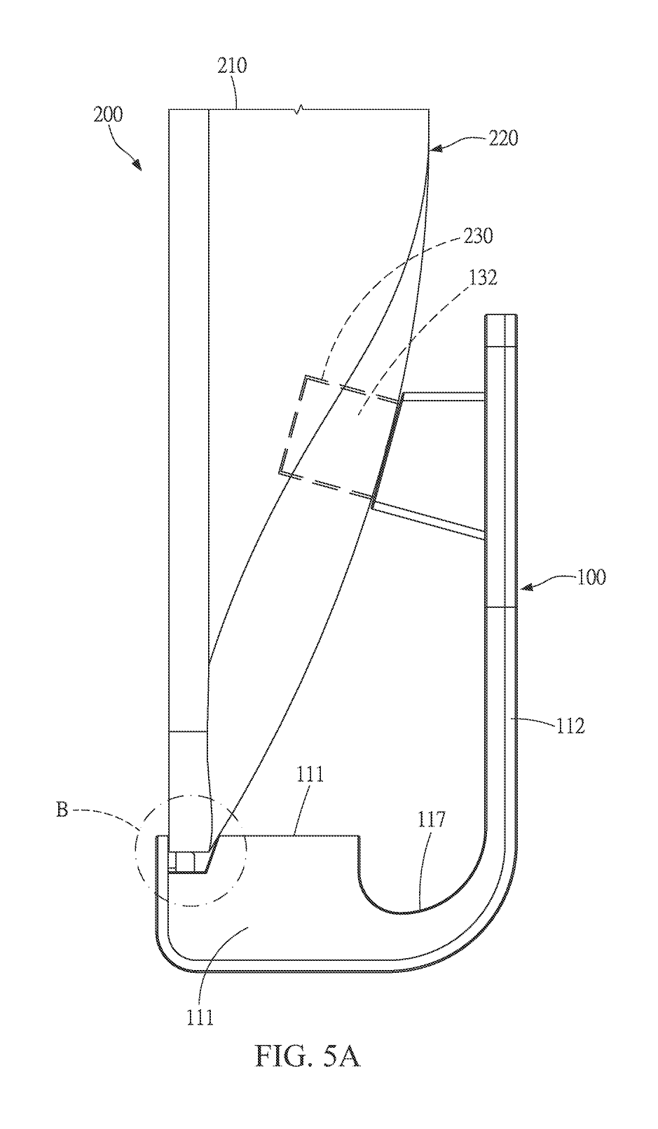

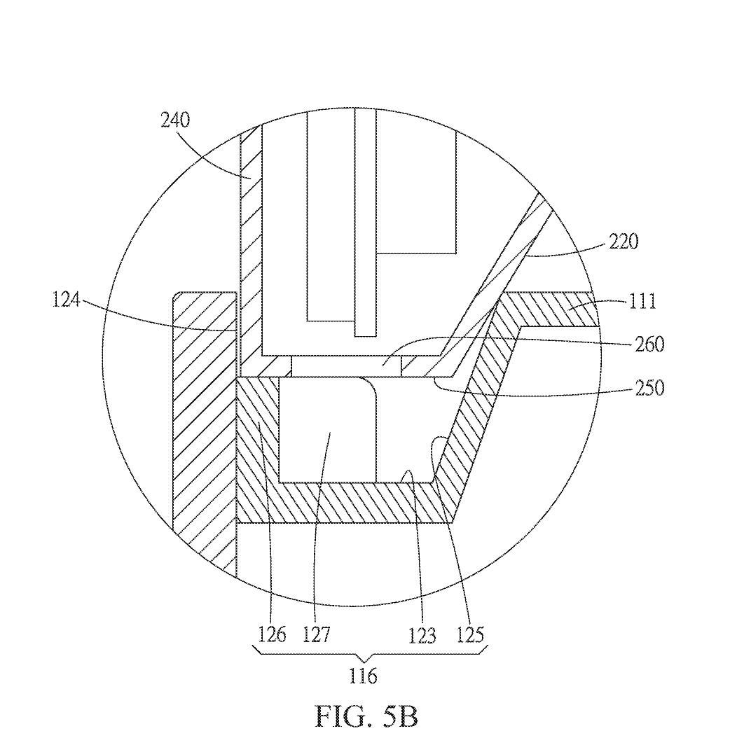

The replicating circuit module 130 is assembled in the receiving space 113 and includes at least one downstream port 131 and an upstream port 132 (in this embodiment, the replicating circuit module 130 includes a plurality of downstream ports 131.). The downstream ports 131 are disposed corresponding to the downstream openings 114. The upstream port 132 is passing through the upstream opening 115 and extended out of the shell 110, so that the upstream port 132 is connected to the connecting port 230 upon assembling with parts of the bottom edge of the casing 210 being positioned in the positioning slot 116 (as shown in FIG. 5A).

FIG. 5A is a schematic assembled view of the port replicator 100 of the first embodiment of the disclosure and the electronic device 200, FIG. 5B is a partial enlarged view of the B region shown in FIG. 5A.

Please refer to FIG. 5A and FIG. 5B, in which when the user wants to connect a downstream device (or a connecting terminal of the downstream device), to the downstream port 131, the abutting portion 111 is abutted against the bottom edge of the front surface 240 of the shell 210 to compensate the inserting force. Moreover, because the downstream port 131 is faced toward the front side of the electronic device 200, the user can connect the downstream device to the connecting port 230 conveniently and easily. Here, the downstream device can be a flash drive, a pen recorder, a mobile phone, etc.

As shown in FIG. 4, the replicating circuit module 130 further includes a circuit board 133. The downstream port 131 and the upstream port 132 are electrically connected to the circuit board 133. Here, the downstream port 131 is assembled on the circuit board 133, and the upstream port 132 is connected to the circuit board 133 via wires 134. The circuit board 133 is capable of having a multiplexer and/or a demultiplexer, so that when the downstream port 131 is connected to the downstream device, the downstream device and the electronic device 200 can be cooperated with each other via the port replicator 100. Here, for clarity's sake, the detail structures (circuits, multiplexer/demultiplexer and other chips or components) of the circuit board 133 are not illustrated.

As shown in FIG. 2, the connecting interface of the downstream port 131, here, an USB interface, is the same as that of the upstream port 132, but embodiments of the disclosure are not limited thereto. In some cases, the connecting interface of the downstream port 131 is different from that of the upstream port 132, or the connecting interfaces between the downstream ports 131 are different; for example, the connecting interface of the upstream port 132 is the USB interface, the connecting interface of one downstream port 131 is an Ethernet interface, the connecting face of another downstream port 131 is the USB interface; in such case, in order to make telecommunication between the electronic device 200 with the modern having the Ethernet interface via the USB interface, the circuit board 133 further has a protocol convertor between USB and Ethernet.

As shown in FIG. 2, the extending portion 112 is extended from the rear end of the abutting portion 111 and bent upward. The extended length of the extending portion 112 is approximately the distance from the connecting port 230 of the electronic device 200 to the bottom edge of the casing 210; however, the extended length depends on from which portion of the abutting portion 111 the extending portion 112 is extended; that is, the extended length of the extending portion 112 which is extended from the upper end of the abutting portion 111 is smaller than that of the extending portion 112 which is extended from the rear end of the abutting portion 111, and in this case, upon assembling only parts of the bottom edge of casing 210 is positioned in the positioning slot 116 for fastening.

As shown in FIG. 2 a bending portion 117 is formed between the extending portion 112 and the abutting portion 111 and is an arc surface, but embodiments of the disclosure are not limited thereto; in some embodiments, the bending portion 117 is a recessed portion without arc surface; that is, the shell 110 further includes a placing groove located at the bending portion 117. Based on this, the user can put small items into the placing groove for storage; for instance, when a mobile phone is connected to the downstream port 131 for charging or data transmission, the mobile phone can be placed in the placing groove.

As shown in FIG. 1, in this embodiment, the opening direction of the connecting port 230 of the electronic device 200 is slightly tilted downward with respect to a horizontal direction. For ease of connection, a sharp angle is formed between the connecting direction D1 of the upstream port 132 and the extending direction D2 of the extending portion 112, but embodiments of the disclosure are not limited thereto; the angle between the connecting direction D1 of the upstream port 132 and the extending direction D2 of extending portion 112 can be another shape angle, a right angle or an obtuse angle, and is depended on the opening direction of the connecting port 230 of the electronic device 200.

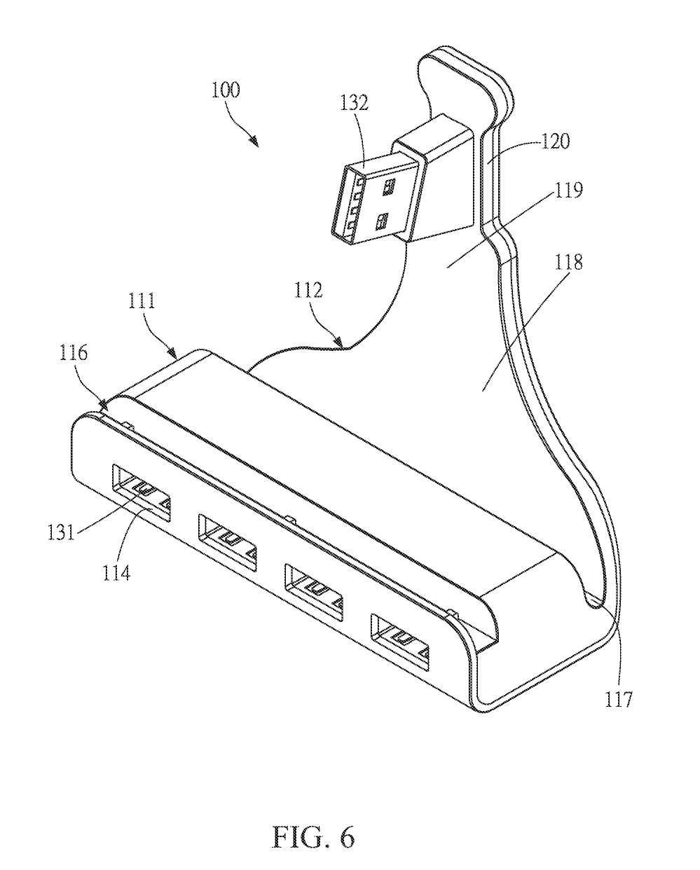

As shown in FIG. 2, the width of the extending portion 112 is gradually reduced from one end thereof which is adjacent to the abutting portion 111 toward the extending direction D2 (that is, toward a direction far from the abutting portion 111), and formed as a sector structure 118, a shank portion 119 is extended from the reduced end of the sector structure 118; but embodiments of the disclosure are not limited thereto, in one embodiment, two sides of the shank portion 119 of the extending portion 112 which corresponds to the upstream opening 115 (namely, the upstream port), are recessed inward to form a neck portion 120 (as illustrated in FIG. 6, which is a perspective view of the port replicator 100 of one implementation aspect of the first embodiment of the disclosure.).

Please refer to FIG. 4, in which the shell 110 can be composed of an upper cover 121 and a lower cover 122 detachably combined with each other via engaging, buckling, locking and means so forth.

The detail structure of the positioning slot 116 is described later. Please refer to FIG. 5B, in which the positioning slot 116 includes a bottom face 123, a front lateral face 124, a rear lateral face 125 and a blocking body 126. The bottom face 123 is located at the bottom portion of the positioning slot 116, the front lateral face 124 is adjacent to the front end of the abutting portion 111 (that is, one end of the abutting portion 111 which is far from the extending portion 112), and is connected to the bottom face 123, such that the front lateral face 124 is contacted with the front surface 240 of the casing 210 upon assembling. The rear lateral face 125 is connected to the bottom face 123 and located opposite to the front lateral face 124 (that is, located adjacent to the extending portion 112). The blocking body 126 is disposed at a connecting portion between the front lateral face 124 and the bottom face 123, and a height of the blocking body 126 is lower than that of the front lateral face 124, and the blocking body 126 is contacted with the bottom surface 250 of the casing 210 upon assembling. Based on this, via the contacting between the front lateral face 124 of the positioning slot 116 and the front surface 240 of the casing 210, a counter force opposite to the direction of the inserting force is provided so as to prevent the port replicator 100 from pushing backward by the inserting force. In addition, in some cases, the electronic device 200 further has a plurality of heat dissipating holes 260 opened at the bottom surface 250 thereof, so that the blocking body 126 is capable of preventing the bottom surface 250 of the casing 210 from contacting with the bottom face 123 of the positioning slot 116; thereby, the port replicator 100 does not cover the heat dissipating holes 260 and the space for gas flowing is provided.

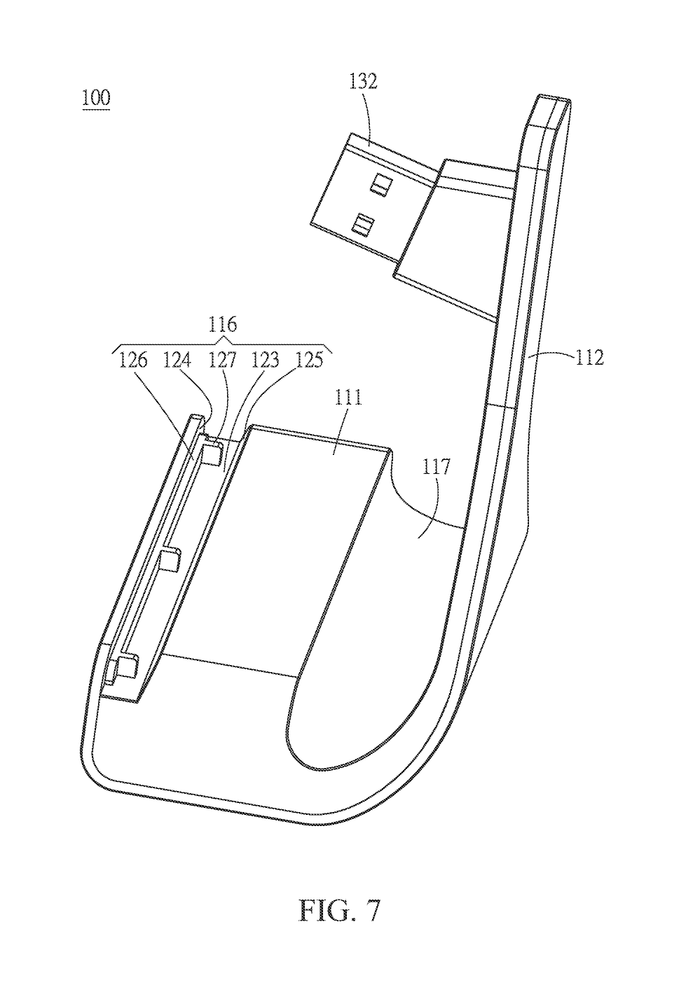

FIG. 7 is another perspective view of the port replicator 100 of the first embodiment of the disclosure.

Please refer to FIG. 5A, FIG. 5B and FIG. 7. The positioning slot 116 further includes a plurality of protruding ribs 127, and one end of each protruding rib 127 is connected to the blocking body 126. Here, the length of each protruding rib 127 is smaller than a distance between the rear lateral face 125 of the positioning slot 116 and the blocking body 126; and, the height of the protruding rib 127 is the same as that of the blocking body 126. Based on this, heat dissipating spaces formed between the protruding ribs 127 correspond to the heat dissipating holes 260 of the casing 210 upon assembling; that is, each heat dissipating space is located below each corresponding heat dissipating hole 260 upon assembling.

Here, the front lateral face 124 is approximately opposite to and parallel with the rear lateral face 125.

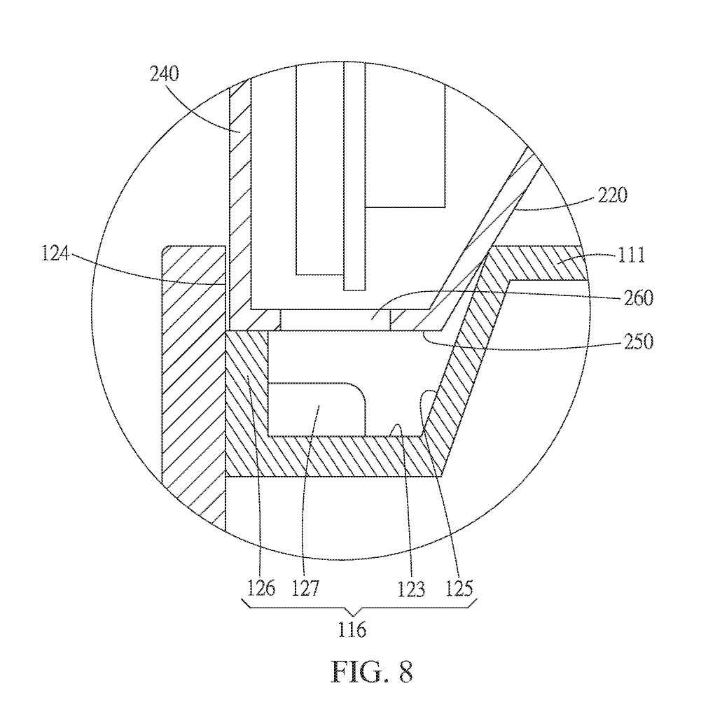

Please refer to FIG. 8, which is a schematic view of the port replicator 100 of one implementation aspect of the first embodiment of the disclosure and the electronic device 200. Here, the height of the protruding rib 127 is lower than that of the blocking body 126, so that airs can flow out from the two sides of the positioning slot 116 easily.

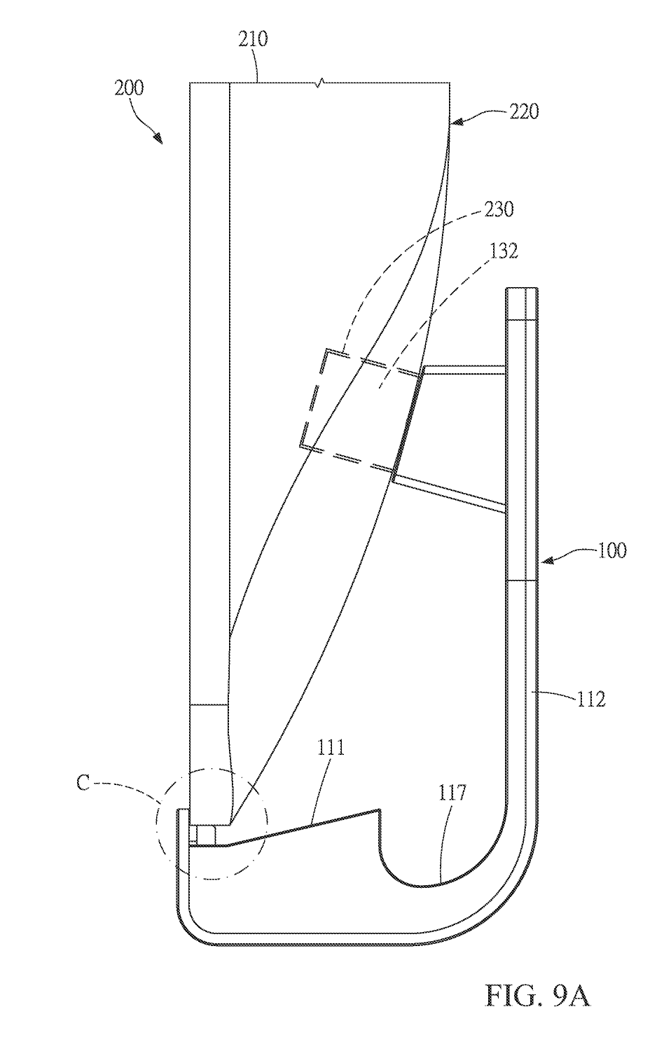

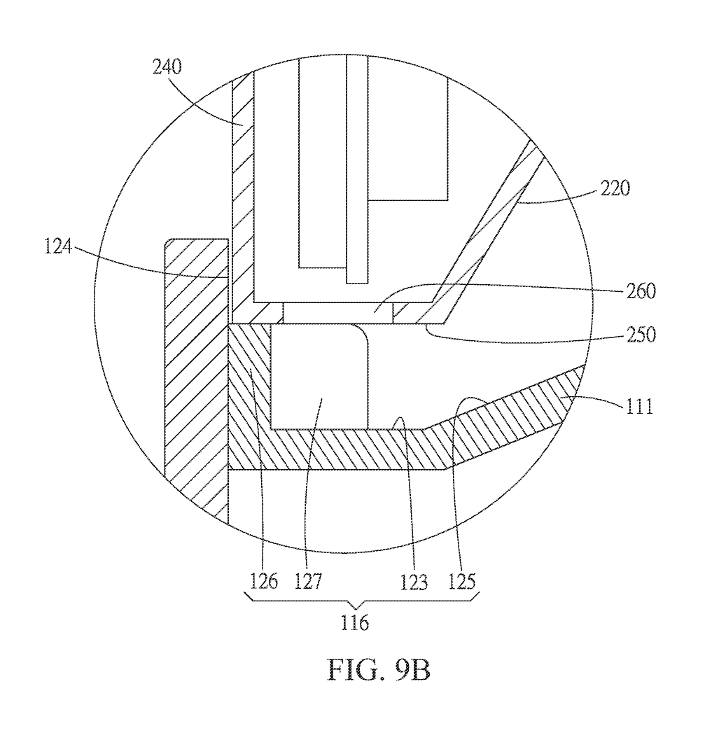

FIG. 9A is a schematic assembled view of a port replicator 100 of a second embodiment of the disclosure and an electronic device 200. FIG. 9B is a partial enlarged view of the C region shown in FIG. 9A. Please refer to FIG. 9A and FIG. 9B, in which the rear lateral face 125 can also be an inclined face inclined from the bottom face 123 toward the rear end of the abutting portion 111, so that the heat dissipating space with larger volume is maintained between the casing 210 of the electronic device 200 and the inclined face.

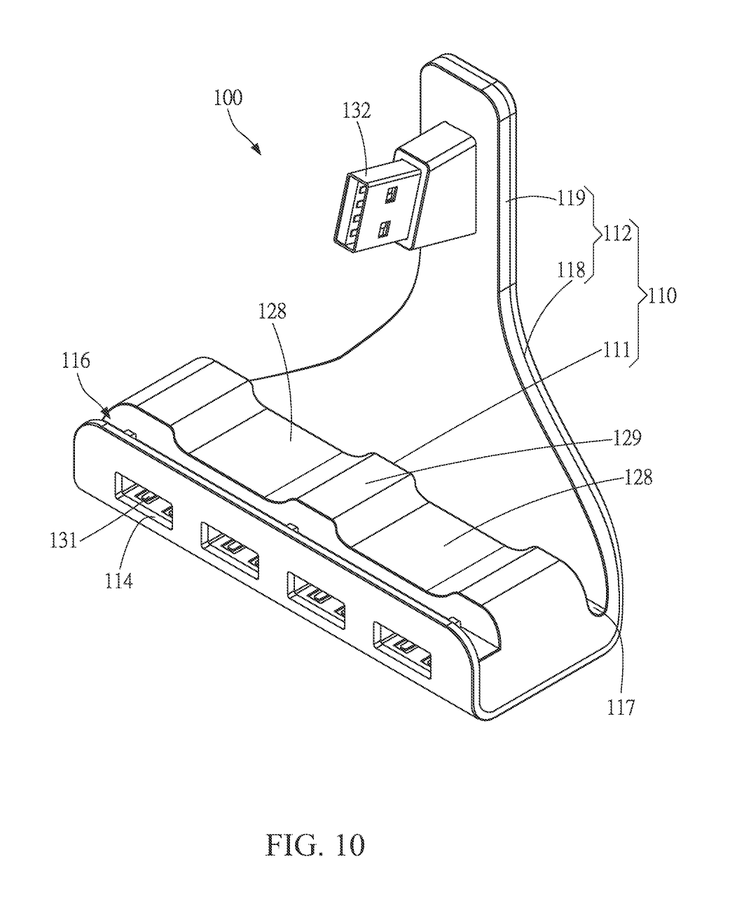

FIG. 10 is a perspective view of a port replicator 100 of a third embodiment of the disclosure. As shown in FIG. 10, the structure of the port replicator 100 of the third embodiment is approximately the same as that of the port replicator 100 of the first embodiment, except that in the third embodiment, the port replicator 100 further includes a plurality of airflow passages 128 located at the abutting portion 111 thereof.

The airflow passages 128 are disposed at the upper end of the abutting portion 111. The opening end of each airflow passage 128 communicates with the positioning slot 116 and the airflow passages 128 are extended toward the extending portion 112. Here, the airflow passages 128 are formed as grooves (that is, the opening end of the airflow passage 128 is disposed at the edge of the upper end of the rear lateral face 125 of the positioning slot 116), or as channels (that is, the opening end of the airflow passage 128 is disposed at the middle region of the rear lateral face 125 of the positioning slot 116). Based on this, in addition to being dissipated from the two sides of the positioning slot 116, heat can also be dissipated backward, thereby improving heat dissipation efficiency.

Here, the opening ends of the airflow passages 128 respectively correspond to the heat dissipating holes 260 of the casing 210 upon assembling; that is, the opening ends are located corresponding to heat dissipating spaces as mentioned above, namely, the protruding rib 127 is disposed corresponding to a separating portion 129 between two adjacent airflow passages 128, but embodiments of the disclosure are not limited thereto, in some embodiments, more than one airflow passages 128 are located corresponding to one heat dissipating hole 260.

From the above description, it is realized that, the port replicator 100 is applicable for the electronic device 200 having the connecting port 230 at the rear face 220 thereof and provides a function of increasing the number of ports for downstream devices. Furthermore, the user can plug the terminal of the downstream device from the front side of the electronic device 200. Although the description mentioned above only shows that the positioning slot 116 is abutted against the bottom edge of the front surface 240 of the casing 210, but embodiments of the disclosure are not limited thereto; in some cases, the positioning slot 116 is abutted against the lateral sides or the bottom edge of the front surface 240 of the casing 210.

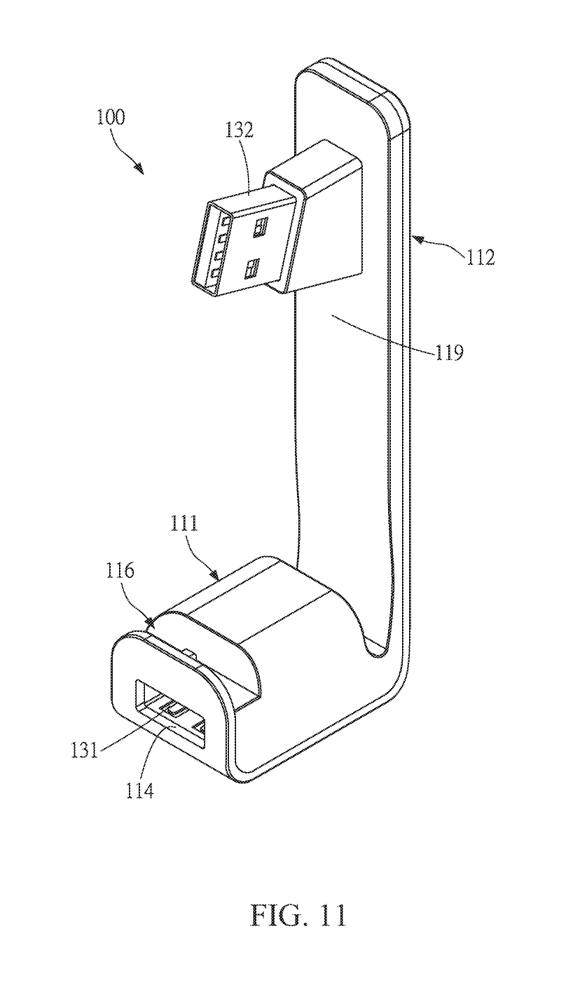

Please refer to FIG. 11, which is a perspective view of a port replicator 100 of a fourth embodiment of the disclosure. Here, the port replicator 100 has only one downstream port 131, and both the connecting interfaces of the downstream port 131 and upstream port 132 are the USB interface, but embodiments of the disclosure are not limited thereto.

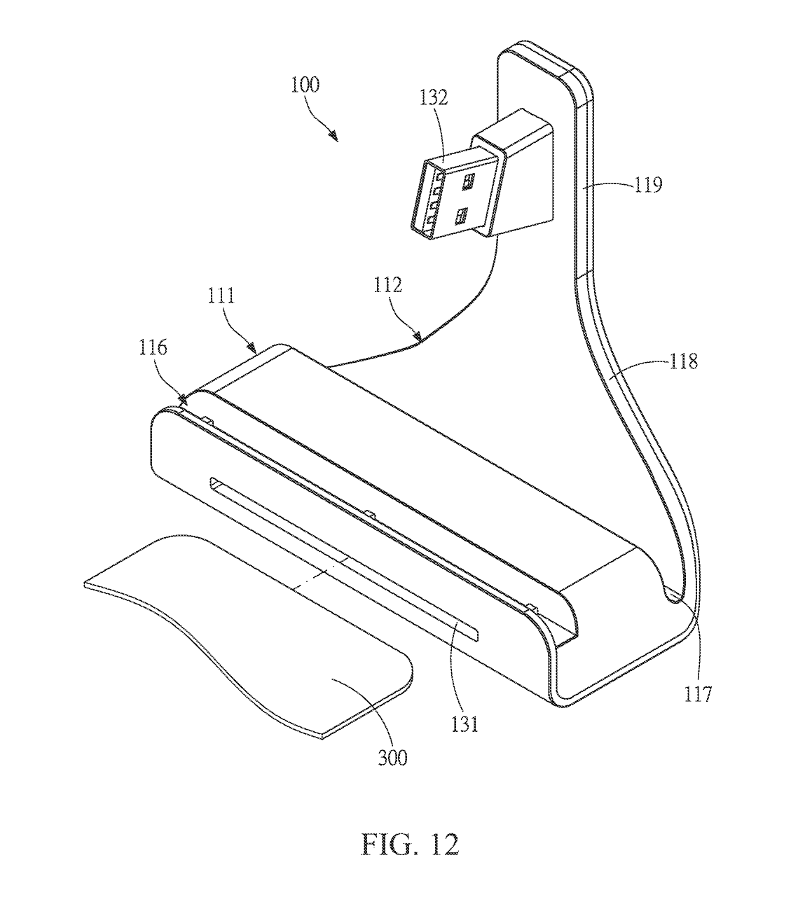

Please refer to FIG. 12, which is a perspective view of a port replicator 100 of a fifth embodiment of the disclosure. The structure of the port replicator 100 of the fifth embodiment is approximately the same as that of the port replicator 100 of the fourth embodiment, except that in the fifth embodiment, the downstream port 131 is a reading interface supportable for IC cards and smart cards, and the upstream port 132 is a port supportable for USB.

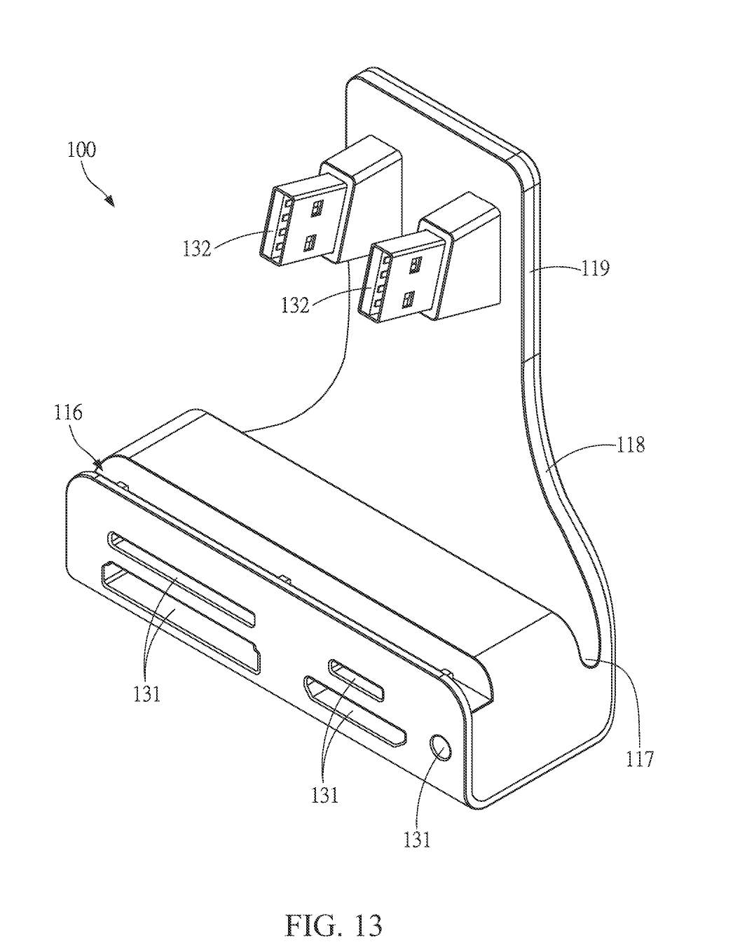

Please refer to FIG. 13, which is a perspective view of a port replicator 100 of a sixth embodiment of the disclosure. Here, the port replicator 100 has a plurality of upstream ports 132 correspondingly connectable to the connecting ports 230 of the electronic device 200; furthermore, the upstream ports 132 are connected to one or more than one downstream ports 131 via different switching circuits of the replicating circuit module 130.

Here, although FIG. 13 shows that the connecting interfaces of the upstream ports 132 are the same, but embodiments of the disclosure are not limited thereto; for example, in one embodiment, the connecting interface of one upstream port 132 is the USB interface, so that the upstream port 132 corresponds to the downstream ports 131 supportable for USB interface and SD memory card interface, while the connecting interface of another upstream port 132 is an audio interface, so that another upstream port 132 corresponds to the downstream port 131 supportable for audio interface.

As above, via the port replicator 100, the plugging direction of the connecting port 230 disposed behind the electronic device 200 is switched to the front side of the electronic device 200 to be plugged conveniently. Furthermore, the user can place the downstream device connected to the downstream port 131 into the bending portion 117 of the port replicator 100. Additionally, via the positioning slot 116, the heat dissipating holes 260 of the electronic device 200 are not shielded and the heat dissipation of the electronic device 200 can be improved. Additionally, via the assembling of one or more than one upstream ports 132, downstream ports 131, and the replicating circuit module 130 (including multiplexer/demultiplexer and protocol convertor), in the port replicator 100, the function of the connecting ports 230 of the electronic device 200 is multiplied, and the number of the downstream device connectable to the connecting port 230 of the electronic device 200 is also increased.

While the disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A port replicator, applicable to an electronic device, a casing of the electronic device having a connecting port disposed at a rear face thereof, the port replicator comprising:
a shell, having an abutting portion and an extending portion connected with each other, wherein the inside of the abutting portion communicates with that of the extending portion to form a receiving space, the abutting portion has at least a downstream opening, an upstream opening and a positioning slot, wherein the downstream opening is disposed at a front end of the abutting portion, the upstream opening is disposed at a rear end of the extending portion, and the positioning slot is disposed at an upper end of the abutting portion; and
a replicating circuit module, assembled in the receiving space has at least a downstream port and an upstream port, wherein the downstream port is disposed corresponding to the downstream opening, and the upstream port passes through the upstream opening and extended out of the shell, so that the upstream port is connected to the connecting port upon assembling with parts of a bottom edge of the casing being positioned in the positioning slot.

2. The port replicator according to claim 1, wherein the positioning slot comprises:
a bottom face, disposed at a bottom portion thereof;
a front lateral face, adjacent to the front end of the abutting portion and connected to the bottom face, such that the front lateral face is contacted with a front surface of the casing upon assembling;
a rear lateral face, connected to the bottom face and located opposite to the front lateral face; and
a blocking body, disposed at a connecting portion between the front lateral face and the bottom face, the height of the blocking body being lower than that of the front lateral face, the blocking body being contacted with a bottom surface of the casing upon assembling.

3. The port replicator according to claim 2, wherein the positioning slot further comprises a plurality of protruding ribs, and one end of each protruding rib is connected to the blocking body.

4. The port replicator according to claim 3, wherein the heights of each protruding rib is smaller than the height of the blocking body.

5. The port replicator according to claim 3, wherein the length of each protruding rib is smaller than a distance between the rear lateral face of the positioning slot and the blocking body.

6. The port replicator according to claim 3, wherein heat dissipating spaces formed between the protruding ribs correspond to the heat dissipating holes of the casing upon assembling.

7. The port replicator according to claim 1, wherein a sharp angle is formed between a connecting direction of the upstream port and an extending direction of the extending portion.

8. The port replicator according to claim 1, wherein the extending portion is extended from the rear end of the abutting portion and bent upward.

9. The port replicator according to claim 8, wherein the shell further comprises a placing groove located at a bending portion between the abutting portion and the extending portion.

10. The port replicator according to claim 9, wherein the bending portion is an arc surface.

11. The port replicator according to claim 1, wherein the width of the extending portion is gradually reduced from one end thereof which is adjacent to the abutting portion toward an extending direction of the extending portion.

12. The port replicator according to claim 1, wherein two sides of the extending portion, which corresponds to the upstream opening, are recessed inward to form a neck portion.

13. The port replicator according to claim 1, wherein the abutting portion further comprises a plurality of airflow passages located at the upper end thereof, an opening end of each airflow passage communicates with the positioning slot and the airflow passages are extended toward the extending portion.

14. The port replicator according to claim 13, wherein the opening ends of the airflow passages respectively correspond to the heat dissipating holes of the casing upon assembling.

15. The port replicator according to claim 14, wherein the positioning slot further comprises a plurality of protruding ribs, and one end of each protruding rib is connected to the blocking body, each protruding rib is disposed corresponding to a separation portion between two of the adjacent airflow passages.

16. The port replicator according to claim 1, wherein the shell can be composed of an upper cover and a lower cover detachably combined with each other via buckling or locking.
